(19) United States
(12) Patent Application Publication
(10) Pub. No.: US 2006/0280550 A1
(43) Pub. Date: Dec. 14, 2006

(54) Profile connecting system

(75) Inventor: Walter Baer, Pfaffikon (CH)

Correspondence Address: DARBY & DARBY P.C., P. O. BOX 5257, NEW YORK, NY, 10150-5257, US

(73) Assignee: Kanya AG

(21) Appl. No.: 11/445,917

(22) Filed: Jun. 1, 2006

(30) Foreign Application Priority Data
Jun. 1, 2005 (EP) 05011815

(51) Int. Cl. B25G 3/00

(52) U.S. Cl. 403/252

(57) ABSTRACT

Profile connecting systems having profile bars and connecting elements and assembly thereof. The profile bars may have at least one axial elongated hole and on the profile outer sides slots for nut block connections. Profile connections may be assembled by inserting and fixing an abutment, for example, a self-cutting threaded insert, into the bore of an axial elongated hole in a first profile bar. Adjacent to the installation length of the threaded insert and of the head of a screw, an axially running wrench opening may be provided in the tubular body of the axial elongated hole. The length and width of the wrench opening may permit guidance therethrough of a assembly tool, for example, socket wrench with joints or with a substantially spherical socket wrench head with flats, at an insertion angle to the longitudinal axis of the profile bar and the coupling of the socket wrench to the head of the screw.

This application claims the benefit of priority from prior European Application 05011815 filed on Jun. 1, 2005, the entirety of which are incorporated by reference herein.

### BACKGROUND OF THE INVENTION

1. Field of the Invention

The invention relates to profile connecting systems, comprising profile bars and connecting elements, and methods for connecting profile bars.

2. Description of Related Art

Profile connecting systems having profile bars made of hot-pressed aluminum or of plastic with a wide variety of connecting elements are known.

The majority of profile connecting systems require machining operations in order to fasten the connecting elements to the profile bar ends, in particular precisely placed drilled holes transversely to the longitudinal axis of the profile bars. More recently, threads have also been cut into axial elongated holes of a first profile bar or self-cutting threaded inserts introduced. In the second profile bar, a screw is inserted through a drilled hole and clamped in the threaded insert in the first profile bar. In the event of alterations to and/or extensions of profile bar constructions at their places of use, e.g., at a trade fair, appropriate machinery is, however, in many cases not available. New profile bar constructions, alterations or extensions often have to be erected, however, at their places of use quickly, precisely and in many cases also for great loads using only simple assembly tools, such as for example a hand drilling machine, etc.

A profile connecting system with polygonal profile bars, preferably with rectangular cross-sections, is known from EP 0458 069 A1. These profile bars have an axial elongated hole and on the profile outer sides slots for nut block connections. In two mutually opposite slot chambers of a profile bar, abutments in the form of self-cutting threaded inserts are screwed in from the end side. In the process, each of the two threaded inserts cuts, at both flanges forming a T-slot and at the bottom of the slot chambers, in each case partial circumferential sections of a thread. The threaded inserts furthermore have a bore for inserting therethrough the shank of a screw in the form of a hexagon socket screw that establishes the profile connection with a nut block arranged in the second profile bar. Owing to the fact that the threaded inserts and the hexagon socket screw are arranged in two mutually opposite T-slot chambers of profile bars, at least two threaded inserts and two hexagon socket screws are required on both sides of a force-neutral bending axis to achieve symmetrical force transmission. The cost for in each case at least two threaded inserts, two hexagon socket screws and two nut blocks and in particular the assembly expenditure is correspondingly high for each bar connection. Furthermore, the shearing-off resistance for the threaded inserts in the self-cut short thread circumferential sections in the T-slot chambers is relatively low. In addition, the visible threaded inserts fitted on both sides in the open T-slot chambers restricts the use of the T-slots in their entirety, in particular insertion of planar elements, and also impairs the aesthetics of such profile bar constructions.

### SUMMARY OF THE INVENTION

The object of the invention is to overcome the disadvantages mentioned in the prior art and to provide a profile connecting system and a method for connecting polygonal profile bars that is cost-effective both from the point of view of material and the assembly expenditure and enables profile bar connections without premachining operations on the profile bars using machine tools. Furthermore, profile bar connections for great loads are also to be producible. An additional objective is to provide, apart from right-angled end side to long side connections, also obtuse- or acute-angled end side to long side connections and miter connections. Angles of approximately 10°-170° are commercially desirable, as well as straight and bent end side to end side connections for great loads. Instead of self-cutting threaded inserts, new and modern anchoring systems, such as adhesive bonding, expansion bushes, spot welding, etc., for fastening the abutment are also to be usable.

With the profile connecting systems and methods according to the invention, it is possible, for example, by means of an insertable abutment and a screw that are arranged in the bore of the elongated hole in the first profile bar, to clamp a tie anchor arranged in the second profile bar without having to perform machining operations on the profile bars by means of machine tools. This makes it possible to design and erect profile bar constructions at the place of use without having to perform costly and time-consuming machining operations in workshops. Furthermore, generally only one each of the necessary connecting elements, e.g., abutment, screw and tie anchor, is required per connection. This saves costs on material and labor, as well as time between design and erection of the profile bar construction. Owing to the arrangement of the connecting elements in the axial elongated hole of the first profile bar, the connection can also absorb high static and/or dynamic forces accordingly. The various fastening options for the abutment in the round bore of the axial elongated hole and the choice of various different tie anchors allows the system according to the invention to be used quickly and cost-effectively for all connections that are frequently employed in practice, such as, for example, end side to long side connections, miter connections and end side to end side connections, at different connecting angles.

The abutment can be introduced and fixed in the round bore of the axial elongated hole in a wide variety of ways. In principle, all currently known fastening techniques, such as, for example, adhesive bonding, synthetic resin bonding, expansion bushes, spot welding, etc., may be used. According to one embodiment, the abutment can be designed as a threaded insert with a self-cutting external thread which is inserted into the bore of the axial elongated hole.

Likewise, for the coupling between a socket wrench for clamping a screw, a wide variety of embodiments can be utilized by those of ordinary skill in the art. Examples of coupling profiles that may be use are hexagon sockets, hexalobular sockets, cross recesses, etc. Furthermore, in the use of the invention, all embodiments of axially rotatable socket wrenches that can be inserted obliquely through the outer slot and through the wrench opening can be employed, such as, for example, those having a cardan joint, articulation axis, etc. According to one exemplary embodiment, the screw may have a cylindrical head with a hexagon socket. Such screws are available at low cost worldwide as standard screws and can be coupled by the screw head to a hexagon socket wrench with a spherical wrench head, at an angle, preferably of (but not required to be) between 15° and 50° to the longitudinal axis of the profile bar, through the wrench opening.

In the case of square profile cross-sections, the bore of the axial elongated hole may be arranged as a central bore and have two force-neutral bending axes. In the case of rectangular cross-sections, generally two or more axial elongated holes may be arranged along one force-neutral bending axis of the profile bar, into which holes abutments may be inserted, if required.

The wrench opening may be preformed during the profile production as an open slot or as a tear-open slot. In the prior-art profiles, preformed wrench openings or profile cross-sections with tear-open slots are absent. According to one exemplary embodiment, one may open the wrench opening using assembly tools over a length of approximately 40-80 mm adjacent to the installation position of the abutment and of the head of the screw in the profile bar.

Tilting of the threaded insert while it is being screwed into axial elongated holes of profile bars can be avoided, in particular with mitered profile bar connections, if the threaded inserts comprise a guide part over approximately 50% of their length with an approximately play-free sliding tolerance with respect to the elongated hole, and a threaded part over approximately 50% of their length.

Cutting edges on the self-cutting threaded part, which may be advantageously slightly conically shaped, can be created for example by at least one clamping slot, etc. on the threaded part.

The longitudinal bore in the threaded insert can perform two tasks. On the one hand, it desirously is large enough for the guidance of the screw therethrough and, on the other hand, it desirously provides form-fitting access for a clamping tool for screwing the threaded insert into the profile bars. According to one embodiment of the invention, the longitudinal bore is provided in the threaded insert over a partial length with, for example, a hexagon socket for inserting a hexagon socket wrench, etc.

The wrench opening for the guidance of a socket wrench through the tubular body of the axial elongated hole may be produced at the place of use of the profile bar construction, e.g., with a hand drilling machine, a small hand router, a small cutting disc, etc. According to an embodiment of the invention, a tear-open slot for opening the wrench opening over a predetermined length by means of simple assembly tools may be provided in the cross-section of the tubular body forming the axial elongated hole. Such a tear-open slot reduces the erection time of a profile bar construction quite considerably. Furthermore, any damage to the slot flanges at the profile outer sides is avoided, so that the latter are available without restriction for further connections. Devices for covering wrench openings for design reasons may also be dispensed with.

In order to anchor self-cutting threaded inserts in the axial elongated hole without great expenditure of force, according to one embodiment the axial elongated hole may be provided along the circumference with axially running ribs. The height of the ribs may be dimensioned somewhat greater than the intended thread depth, and the rib spacing may be dimensioned equal to or greater than the rib width.

Apart from right-angled profile bar connections, there is also often a need for obtuse- or acute-angled miter connections with angles, for example, of between 10°-170° and straight axial connections. Such additional connection examples may be produced with the same clamping elements, e.g., insertable abutments or threaded inserts, screws, and tie anchors adapted to the desired connection, using the same clamping method. Various devices may be used as tie anchors, for example, simple nut block with threads cut transversely or obliquely to the slot longitudinal axis, nut blocks having an articulated cylindrical nut with a blind-hole thread for the screw, two cylindrical nuts connected by a joint and each with a blind-hole thread for screws, a cylindrical nut open at both ends and with an internal thread for screws or an abutment with a continuous thread, etc.

For the transmission of large forces, the cylindrical nuts may have, according to certain embodiments, an outside diameter that is smaller by a sliding tolerance than the bore of the axial elongated hole.

Additional security against displacement of a right-angled end side to long side node may be achieved, according further embodiments, if a point with an angle of approximately 90° is made on the shank of the screw and the length of the shank permits notching in the slot bottom of the second profile bar.

With the connecting system according to the invention, it is possible for the width of the wrench opening to be adapted to or be less than the width of the T-slots arranged at the outer sides of the profile bar. The width of the wrench opening may be adapted to the width of the slot preceding it. This restriction of the width of the wrench opening allows the wrench opening to be provided as a continuous wrench slot in the cross-section of the profile bar during its production and the bending strength, reduced thereby, of the profile bar to be regained by cross-sectional optimization, if necessary. In the case of a continuous wrench slot, an abutment fixing in the axial elongated hole by adhesive bonding instead of a self-cut threaded can be particularly advantageous.

In the use of the connecting system according to the invention, apart from the low-cost simple connecting elements, the small number of simple method steps which can all be performed at the place of erection or use of the profile bar construction also contribute to the cost-effectiveness.

Depending on the position of the connecting node in the profile bar construction, the introduction and guidance of the screw through the axial elongated hole to the abutment may be time-consuming and difficult. In order to avoid these difficulties, according to embodiments of the invention, one may provide an inwardly projecting annular edge in the abutment or in the threaded insert at the end of the longitudinal bore on the side of the guide part. The annular edge may be dimensioned such that it engages with play in the thread of the screw and loosely holds the screw in the threaded insert.

### BRIEF DESCRIPTION OF THE DRAWINGS

The foregoing and other features of the present invention will be more readily apparent from the following detailed description and drawings of illustrative embodiments of the invention where like reference numbers refer to similar elements throughout and in which:

FIG. 1 shows a cross-section of a profile bar according to embodiments of the invention;

FIG. 2 shows connecting elements that may be used for a profile bar connection according to embodiments of the invention;

FIG. 3 shows a right-angled profile bar connection in a fully assembled state according to embodiments of the invention;

FIG. 4 shows a plan view of FIG. 3 with the socket wrench removed according to embodiments of the invention;

FIG. 5 shows a cross-section of a profile bar according to further embodiments of the invention;

FIG. 6 shows a further embodiment of a right-angled profile bar connection according to the invention;

FIGS. 7 and 7a show further embodiment of acute-angled profile bar connections according to the invention;

FIG. 8 shows a further embodiment of a straight axial profile bar connection according to the invention; and

FIG. 9 shows a cross-section of a further embodiment of a profile bar according to the invention.

### DESCRIPTION OF EMBODIMENTS OF THE INVENTION

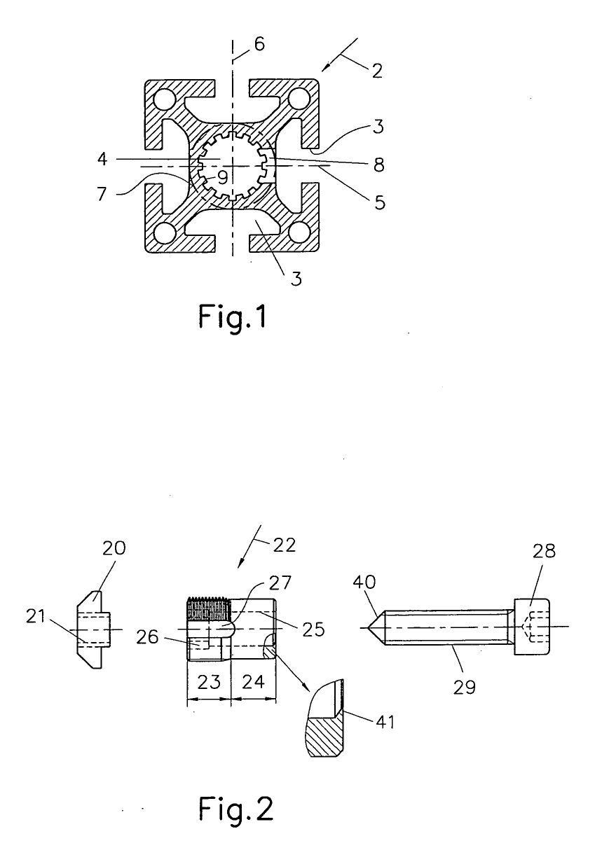

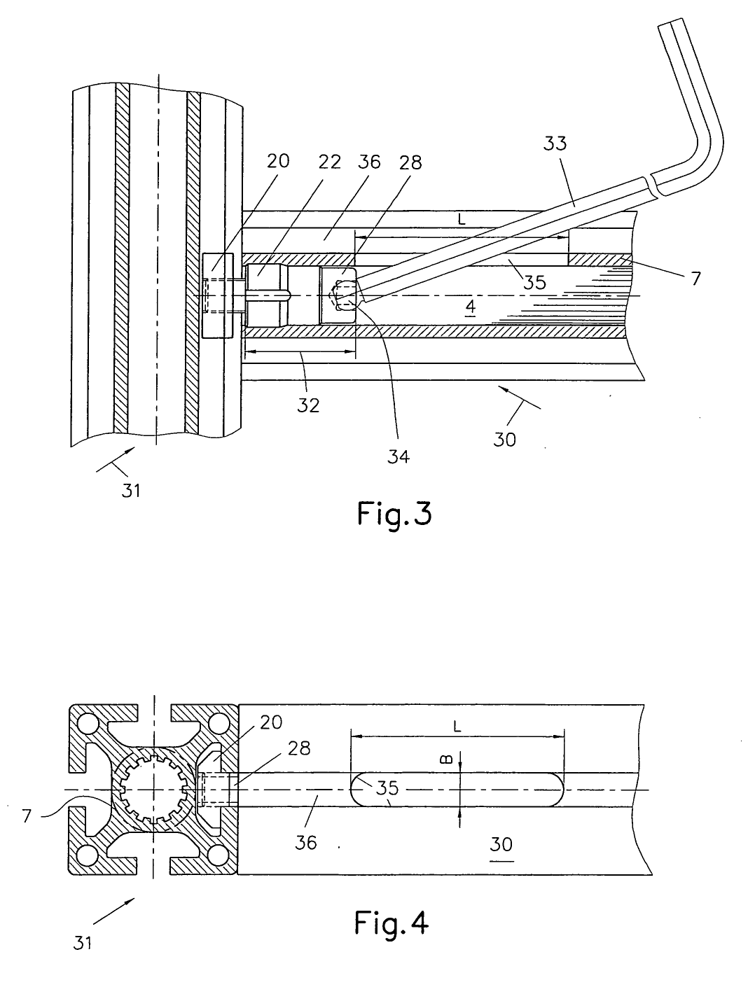

FIG. 1 is a typical square cross-section of a profile bar 2 for profile bar constructions. Such profile bars 2 generally have, on at least one profile outer side, slots 3 for receiving nut blocks. Arranged in the centre of the cross-section is an axial elongated hole 4 which has force-neutral bending axes 5 and 6. In a rectangular cross-section, for example, two axial elongated holes with only one force-neutral bending axis could be arranged. Situated in a tubular body 7 which encloses the axial elongated hole 4 and which is indicated by a chain line is a wrench opening 8 which has a width approximately equal to that of the slot 3 and is additionally explained in FIG. 3. Axially running ribs in the axial elongated hole 4 are illustrated at 9. Such ribs 9 facilitate the cutting of threads, in particular by means of self-cutting threaded inserts.

In FIG. 2, at 20 a nut block adapted to a slot chamber cross-section is provided with a thread 21. Instead of such nut blocks 20, simple plate-shaped nut blocks may also be employed. A threaded insert 22 with a self-cutting, conically shaped, externally threaded part 23, which may be conically shaped, and a guide part 24 constitutes one embodiment of an abutment. Other abutments may be used, e.g., adhesive bonding sleeves, expansion bushes, etc. The threaded part and the guide part each may take up approximately 50% of the total length of the threaded insert 22. The threaded insert 22 may furthermore be provided with a bore 25 for guiding the shank 29 of a hexagon socket screw 28 therethrough. In the shown embodiment, the side of the threaded part 23 the bore 25 is widened over a partial length to a hexagon socket 26 for inserting a hexagon socket wrench. On the opposite side of the hexagon socket 26, the longitudinal bore 25 may be provided with an inwardly projecting annular edge 41. To produce cutting edges on the external thread 23, at least one clamping slot 27 may be provided. The length of the shank 29 of the hexagon socket screw 28 may be determined by the choice of the length and the screwing-in depth of the threaded insert 22 in the profile bar and, if desired, standard shank lengths may be chosen. The head of the hexagon socket screw 28 may be provided with a hexagon socket. Instead of the hexagon socket screw, screws and other coupling profiles for socket wrenches may be chosen as would be understood by those of ordinary skill in the art. The screw 28 may have on the shank 29 a point 40 with an angle of approximately 90°.

In FIGS. 3 and 4, a first profile bar 30 is connected to a second profile bar 31 by connecting elements, such as those, e.g., illustrated in FIG. 2 and comprising nut block 20, threaded insert 22 and hexagon socket screw 28. A hexagon socket wrench 33 with a spherical hexagon socket wrench head 34 is illustrated still inserted in FIG. 3. The connection may be assembled according to the following steps. A wrench opening 35 is made, for example, by means of assembly tools, in the first profile bar 30 adjacent to the installation length 32 of the threaded insert 22 and of the hexagon socket screw 28 in the tubular body 7 surrounding the axial elongated hole 4. The length (L) of the wrench opening 35 is chosen so as to be sufficient to insert the assembly tool, e.g., hexagon socket wrench 33, an articulated wrench, etc. Subsequently, the self-cutting threaded insert 22 is screwed into the axial elongated hole 4 in the first profile bar 30, e.g., by means of a hexagon socket wrench, from the end side and in doing so a thread is simultaneously cut in the elongated hole 4. The guide part 24 (FIG. 2) ensures centering of the threaded insert 22 in the elongated hole 4. The hexagon socket screw 28 can now be introduced from the other end of the profile bar 30 into the elongated hole 4 and through the bore 25 (FIG. 2) of the threaded insert 22. The hexagon socket wrench 33 can now be inserted, by its approximately spherical hexagon socket wrench head 34 with flats, obliquely, i.e., at an angle of between approximately 10°-40°, into the hexagon socket in the head of the hexagon socket screw 28 and, after positioning the nut block 20 in the second profile bar 31, the connection of the two profile bars can be established by means of the hexagon socket screw and the hexagon socket wrench can subsequently be removed. The T-slot chamber 36 above the wrench opening 35 remains undamaged, as can be seen in FIG. 4, and is available for further profile bar connections, etc. as desired.

In many cases, it is desirable to be able to introduce the screw into the bore of the axial elongated hole together with the abutment. For this purpose, at the guide-side end in the abutment or in the threaded insert 22, the longitudinal bore 25 (FIG. 2) may be provided with an inwardly projecting annular edge 41 that can engage loosely in the thread of the screw 28. The screw may be fastened by its thread to this annular edge 41 and screwed into the profile bar together with the threaded insert. As the screw 28 is being clamped to the tie anchor 20, the annular edge 41 loses the holding function on the end of the thread in the region of the screw head and thus enables correct clamping of the tie anchor.

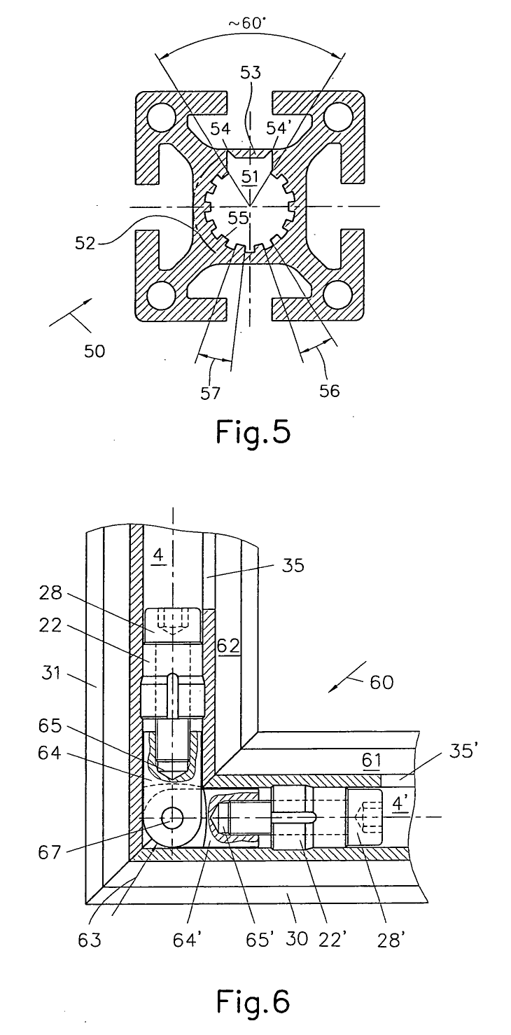

FIG. 5 illustrates a cross-section of a profile bar 50 according to one embodiment. An essential difference of this profile bar 50 from the cross-section in FIG. 1 consists in the formation of an axial elongated hole 51. At 53 a tear-open slot has been preformed in a tubular body 52 (indicated by chain lines) during the production of the profile bar 50. Such a tear-open slot 53 has on both sides preformed reduced cross-sections 54, 54′ that form predetermined tear-open locations. After a delimiting hole has been drilled into the tear-open slot 53 at each end of an intended wrench opening, the tear-open slot 53 between the two drilled delimiting holes may be opened by tearing open, by means of a rod-shaped tool, for example, a screwdriver, and the intended wrench opening may thereby be made quickly and dimensionally accurately in terms of its width and length. Where the length of the wrench opening is only a small fraction of the profile bar length, for example, only approximately 5 cm to 8 cm, the loss in strength as a result of the opened tear-open slot is negligible. Also, the approximately 60′-reduced circumference of the bore of the axial elongated hole 51 available for cutting a thread for a threaded insert or for adhesively bonding an abutment therein is still sufficient to absorb high static and dynamic forces of the profile connection. At 55, axially running ribs along the circumference of the bore of the axial elongated hole 51 are illustrated. The height of the ribs 55 may be somewhat greater than an intended thread depth of a threaded insert. A rib spacing 56 may be chosen to be approximately equal to or greater than a rib width 57.

FIG. 6 illustrates a mitered profile bar connection 60 at an angle of 90°. The angle could also be less than or greater than 90°, for example 150°. The two profile bars 61 and 62 may be cut at the end side at an angle of 45°. In each bar, a threaded insert 22, 22′ may be screwed into the bore of the elongated holes 4, 4′. A tie anchor 63 comprises, for example, two cylindrical nuts 64, 64′, each with a blind-hole thread 65, 65′ for the hexagon socket screws 28, 28′. On the sides facing away from the blind-hole thread 65, 65′, the two cylindrical nuts 64, 64′ may be connected by a joint 67. Using the two hexagon socket screws 28, 28′, the tie anchor 63 is clamped in the profile bars 61, 62 against the threaded inserts 22, 22′ and thus the miter connection is established. The wrench openings are indicated at 35, 35′.

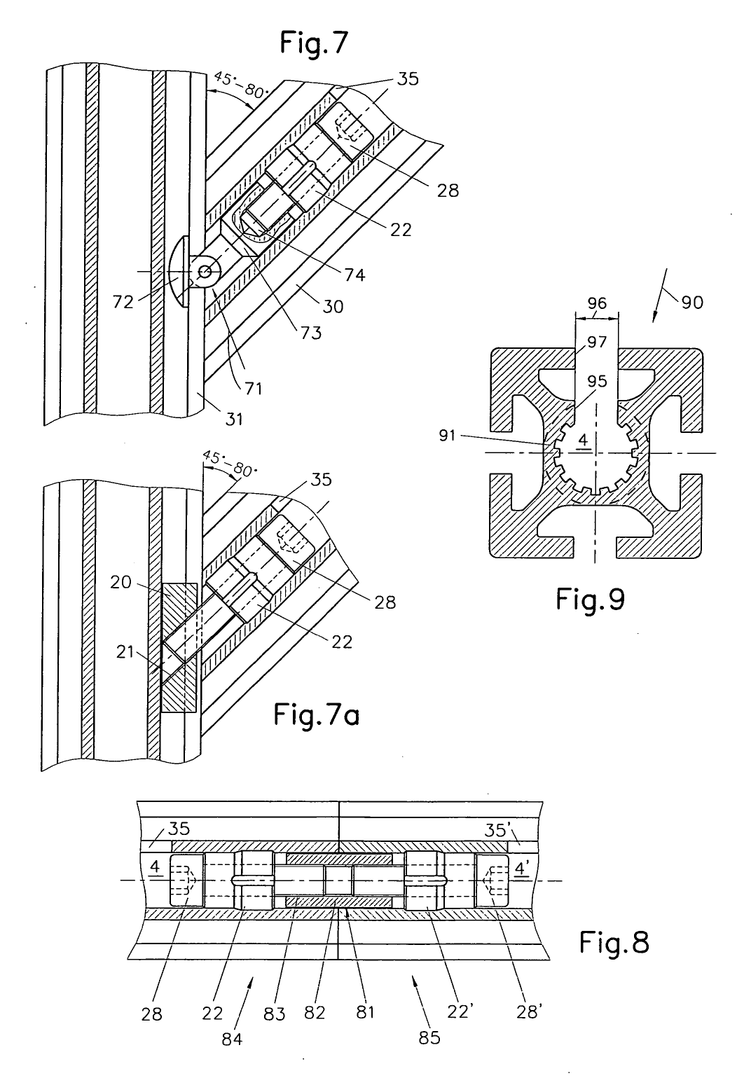

FIG. 7 shows an acute-angled end side to long side connection. The tie anchor 71 comprises, in this example, a nut block 72 having an articulated cylindrical nut 73 with a blind-hole thread 74 for the hexagon socket screw 28. The wrench opening is indicated at 35. Instead of the nut block 72 having the articulated cylindrical nut 73, it is possible, as illustrated in FIG. 7a, for the hexagon socket screw 28 to engage directly in a nut block 20 with an obliquely arranged thread 21.

FIG. 8 illustrates a straight axial end side to end side connection. A tie anchor 81 in the form of a cylindrical nut 82 open at both ends may be provided with an internal thread 83 for the hexagon socket screws 28, 28′. The cylindrical nut 82 is introduced into the bore of the axial elongated hole 4, 4′ in the first and second profile bar 84 and 85, respectively, by a partial length in each case and is clamped to the threaded inserts 22, 22′ by the hexagon socket screws 28, 28′. The wrench opening is indicated at 35, 35′. In the case of a substantially straight end side to end side connection, in a variant (not illustrated in FIG. 8), the use of the cylindrical nut 82 may be dispensed with if one of the two threaded inserts 22, 22′ is provided with a nut thread in the through-hole for an elongated screw. The elongated screw may then be directly clamped in the threaded insert of the profile bar to be connected.

In FIG. 9, in the cross-section of a profile bar 90, a wrench slot 95 has been formed in the tubular body 91, which forms the axial elongated hole 4, during the pressing of the profile bar. In this example, the width of the wrench slot 95 corresponds to the width of an outer slot 96. The wrench slot 95 in the tubular body 91 reduces the bending moment of the profile bar 90. By suitably increasing the wall thickness of the tubular body 91, the bending moment of the profile bar 90 may be increased again, if necessary. With such profile bars 90, opening of a wrench opening is no longer necessary and profile bar constructions may be erected at the place of use even more quickly with a minimum of assembly tools. Profile bars 90 with an elongated wrench slot 95 may also be used for abutment fastenings using adhesives, synthetic resins etc. The wrench slot 95 in the tubular body 91 may, for example, be filled with the adhesive etc. and closed off over the length of the abutment after installation of the abutment in the profile bar.

Those skilled in the art will recognize that the materials and methods of the present invention will have various other uses in addition to the above described embodiments. They will appreciate that the foregoing specification and accompanying drawings are set forth by way of illustration and not limitation of the invention. It will further be appreciated that various modifications and changes may be made therein without departing from the spirit and scope of the present invention, which is to be limited solely by the scope of the appended claims.

What is claimed is:

1. A profile connecting system comprising:
a first profile bar comprising a polygonal cross-section with slots on outer sides thereof and a body forming an axially elongated cavity therein;
a second profile bar having at least one clamp tie anchor therein;
at least one abutment axially insertable into the cavity and fixable therein and having at least one bore;
at least one first fastener insertable through the at least one bore and adapted to engage the at least one clamp tie;
wherein the body further includes an axial wrench opening adapted for passage of a wrench into the cavity at an angle to a longitudinal axis of the cavity and coupling of the wrench to a head of the at least one first fastener.

2. A profile connecting system according to claim 1, wherein the abutment comprises a threaded insert having a self-cutting external thread.

3. A profile connecting system according to claim 1, wherein the at least one first fastener has a profile for coupling with a wrench.

4. A profile connecting system according to claim 1, wherein the angle is between about 10° and about 50°.

5. A profile connecting system according to claim 1, wherein the cavity is located along at least one force-neutral bending axis of the first profile bar.

6. A profile connecting system according to claim 1, wherein the wrench opening has a length between about 40 mm to about 80 mm located adjacent the abutment and head of the at least one first fastener.

7. A profile connecting system according to claim 1, wherein the second profile bar has a T-slot and the at least one clamp tie anchor is located therein.

8. A profile connecting system according to claim 7, wherein the at least one clamp tie anchor comprises a nut block with an internally threaded hole for the at least one first fastener.

9. A profile connecting system according to claim 7, wherein the at least one clamp tie anchor comprises a nut block having an articulated cylindrical nut with a blind-hole thread for the at least one first fastener.

10. A profile connecting system according to claim 7, wherein the cylindrical nut has an outside diameter smaller than a diameter of the cavity by a sliding tolerance.

11. A profile connecting system according to claim 1, wherein:
the second profile bar has an axially elongated cavity with the at least one clamp tie anchor therein; and
further comprising at least one abutment axially insertable into the second profile bar cavity and fixable therein with at least one bore and at least one second fastener insertable therethrough and adapted to engage the at least one clamp tie; and
wherein the at least one clamp tie anchor is insertable into the first profile bar cavity and clampable by the at least one first and second fasteners.

12. A profile connecting system according to claim 11, wherein the at least one clamp tie anchor comprises two cylindrical nuts connected by a joint, each of the two cylindrical nuts having a blind-hole thread on a side facing away from the joint adapted to receive one of the at least one first and second fasteners.

13. A profile connecting system according to claim 12, wherein each of the cylindrical nuts has an outside diameter smaller than a diameter of the first and second profile bar cavities by a sliding tolerance.

14. A profile connecting system according to claim 11, wherein the at least one clamp tie anchor comprises a cylindrical nut with two ends, each having an internally threaded hole adapted to receive one of the at least one first and second fasteners.

15. A profile connecting system according to claim 15, wherein the cylindrical nut has an outside diameter smaller than a diameter of the first and second profile bar cavities by a sliding tolerance.

16. A profile connecting system according to claim 2, wherein the threaded insert has an internal thread whereby the at least one abutment also comprises the at least one claim tie anchor.

17. A profile connecting system according to claim 2, wherein the threaded insert includes a guide part and a threaded part.

18. A profile connecting system according to claim 17, wherein the threaded part has at least one clamping slot.

19. A profile connecting system according to claim 2, wherein the bore of the threaded insert includes a hexagon socket.

20. A profile connecting system according to claim 1, wherein the second profile bar has a slot bottom and the at least one first fastener includes a shank having a point with an angle of about 90° adapted to notch into the slot bottom.

21. A profile connecting system according to claim 1, wherein the wrench opening comprises a tear-open slot in the body having preformed predetermined tear-open locations of a predetermined length, whereby the wrench opening is adapted to be torn open by assembly tools.

22. A profile connecting system according to claim 1, wherein the body further comprises a wrench slot.

23. A profile connecting system according to claim 2, wherein the cavity includes axially running ribs on a circumference thereof, a height of the ribs is greater than an intended threaded depth of the threaded insert, and rib spacing is not less than a rib width.

24. A profile connecting system according to claim 1, wherein a width of the wrench opening is not less than a width of the slots.

25. A profile connecting system according to claim 1, wherein the cavity has an inwardly projecting annular edge adapted to engage the at least one first fastener.

26. A method for connecting the first and second bars of claim 1 comprising:
inserting the at least one abutment into the cavity;
fixing the at least one the abutment inside the cavity;
inserting the at least one first fastener through the at least one bore;
inserting a wrench through the wrench opening at an insertion angle of between about 10° to about 40° to the longitudinal axis of the cavity; and
using the wrench to engage the at least one fastener to the clamping tie anchor, thereby connecting the first profile bar and the second profile bar.

27. The method of claim 26, wherein the wrench opening comprises a tear-open slot in the body having preformed predetermined tear-open locations of a predetermined length adjacent to a predetermined installation position of the at least one abutment, and further comprising tearing opening the wrench opening using assembly tools.

28. The method of claim 26, further including:
locating preformed predetermined tear-open locations in the body adjacent to a predetermined installation position of the at least one abutment;
creating a tear-open slot proximate the cavity at said locations; and
opening the wrench opening by tearing the tear-open slot over a predetermined length.
